(19) United States
(12) Patent Application Publication
(10) Pub. No.: US 2003/0173037 A1
(43) Pub. Date: Sep. 18, 2003

(54) Lift cord locking device for a venetian blind

(76) Inventor: Tai-Ping Liu, Taichung Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/099,033

(22) Filed: Mar. 13, 2002

(51) Int. Cl. E06B 9/324

(52) U.S. Cl. 160/178.2

(57) ABSTRACT

A lift cord locking device has a main frame, a roller, a locking frame and a catch frame. The main frame has a base plate and two side walls. Each of the side walls has an engaging segment extending outward from the top of the side wall. The roller is rotatably mounted between the side walls, and the roller is located below a middle position of the side walls. Accordingly, the main frame can be positioned in the headrail of the Venetian blind in different directions. The use of the locking device is versatile. With a low position of the roller, the angle of the lift cord is smooth even when the locking device is close to the tilt rod support. This can keep the lift cord from contacting the other object. The safety of using the lift cord locking device is improved.

### BACKGROUND OF THE INVENTION

1. Field of the Invention

The present invention relates to a lift cord locking device, and more particularly to a lift cord locking device for a Venetian blind and which is versatile in use.

2. Description of Related Art

With reference to FIGS. 6 to 8, a conventional lift cord locking device (50) for a Venetian blind in accordance with the prior art comprises a frame, a roller (54) and a locking bolt (56). The frame is substantially U-shaped and has a base plate for the lift cord (60) of the Venetian blind extending through the base plate in a longitudinal direction, and the frame further has two side walls (52). Wherein, the lift cord (60) is connected with the slats (not shown) of the Venetian blind, such that the slats can be stacked closer by means of pulling the lift cord (60). An engaging tab (522) extends outward from the top of one of the side walls (52) to engage with one of the upper bent portions of the headrail (not shown) of the Venetian blind, such that the frame can be securely positioned in the headrail. The roller (54) is rotatably mounted between the side walls (52) for the lift cord (60) passing around the top of the roller (54), such that the lift cord (60) extends along a lateral direction to the tilt rod support (not shown) in the headrail. The locking bolt (56) is slidably mounted between the side walls (52) along inclined slots (524) defined in the side walls (52). The outer surface of the locking bolt (56) is formed as a rough surface to provide good purchase.

To lock the lift cord (60), the lift cord (60) is pulled sideward and presses the rough surface of the locking bolt (56). The locking bolt (56) slides upward along the inclined slots (524) and squeezes the lift cord (60) in cooperation with the roller (54). Consequently, the lift cord (60) will be locked to keep the slats from falling when the slats are stacked together.

However, because only one side wall (52) has the engaging tab (522) to engage with the headrail, the conventional locking device (50) can only be positioned in one desired direction. If the direction of pulling the lift cord (60) in an intended locking action faces a wall or another object, the action is easily blocked by the wall or the object. To lock the lift cord (60) with the conventional locking device (50) is troublesome, and the use of the conventional lift cord locking device (50) is not versatile.

With reference to FIGS. 9 and 10, another conventional lift cord locking device (70) in accordance with the prior art comprises a main frame, a roller (74), a locking frame (75) and a catch frame (76). The main frame comprises a base plate (71) and two side walls (72). The side walls (72) respectively extend upward from opposite sides of the base plate (71). One of the side walls (72) has an engaging tab (722) extending outward from the top of the side wall (72) to engage with the upper bent portion of the headrail (not numbered). The roller (74) is rotatably mounted between the side walls (72). The locking frame (75) is pivotally mounted between the side walls (72) and is located below the roller (74). The catch frame (76) is co-axially mounted with the locking frame (75). The lift cord (80) extends through the base plate (71) and the catch frame (76) in a longitudinal direction and passes around the top of the roller (74) to extend to the tilt rod support (not numbered) in a lateral direction.

When the lift cord (80) is pulled sideward, the catch frame (75) and the locking frame (76) will pivotally rotate relative to the main frame and will squeeze the lift cord (80) so as to lock the lift cord (80). However, because only one side wall (72) of the conventional locking device (70) has the engaging tab (722), the use of the conventional lift cord locking device (70) is also not versatile. In addition, the location of the roller (74) of the conventional locking device (70) is higher than the middle position of the side walls (72). The lift cord (80) will extend into the tilt rod support at a large angle, especially the distance between the locking device (70) and the tilt rod support is closer and the angle of the lift cord (80) is larger than in the first cited art. The lift cord (80) will contact the edge of the passage in the tilt rod support or other object, and the lift cord (80) is easily worn and broken during use. Such damage to the cord (80) results in that the slats will unintentionally fall when the lift cord (80) is broken. This is very dangerous, and the safety of the using the lift cord locking device (70) must be improved.

To overcome the shortcomings, the present invention tends to provide a lift cord locking device to mitigate or obviate the aforementioned problems.

### SUMMARY OF THE INVENTION

The main objective of the invention is to provide a lift cord locking device for a Venetian blind and having a versatile use. The lift cord locking device has a main frame, a roller, a locking frame and a catch frame. The main frame has a base plate and two side walls. The side walls respectively extend upward from opposite sides of the base plate. Each of the side walls has an engaging segment extending outward from the top of the side wall. The roller is rotatably mounted between the side walls, and the roller is located below a middle position of the side walls. The locking frame is pivotally mounted between the side walls and is below the roller. The catch frame is co-axially mounted with the locking frame. In such an arrangement, the main frame can be positioned in the headrail of the Venetian blind in different direction, the use of the locking device is versatile. In addition, with a low position of the roller, the lift cord will extend at a smooth angle even when the locking device is very close to the tilt rod support. This can keep the lift cord from contacting the other object and from being broken during use and thus the safety of using the lift cord locking device is improved.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a lift cord locking device in accordance with the present invention;

FIG. 2 is a cross sectional front plan view of the lift cord locking device in FIG. 1;

FIG. 3 is an operational front plan in cross section of the lift cord locking device in FIG. 1 showing that the lift cord is locked by the locking frame and the catch frame;

FIG. 4 is a cross sectional front plan view of the lift cord locking device in FIG. 1 with a tilt rod support mounted in a headrail of the Venetian blind;

FIG. 5 is side plan view in partial cross section of the lift cord locking device with the headrail of the Venetian blind in FIG. 4;

FIG. 6 is a perspective view of a conventional lift cord locking device in accordance with the prior art;

FIG. 7 is a cross sectional front plan view of the conventional lift cord locking device in FIG. 6;

FIG. 8 is an operational front plan view in cross section of the conventional lift cord locking device in FIG. 6 showing that the lift cord is in a locking condition;

FIG. 9 is a perspective view of another conventional lift cord locking device in accordance with the prior art; and

FIG. 10 is a cross sectional front plan view of the conventional lift cord locking device in FIG. 9 with a tilt rod support mounted in a headrail of the Venetian blind.

### DETAILED DESCRIPTION OF PREFERRED EMBODIMENT

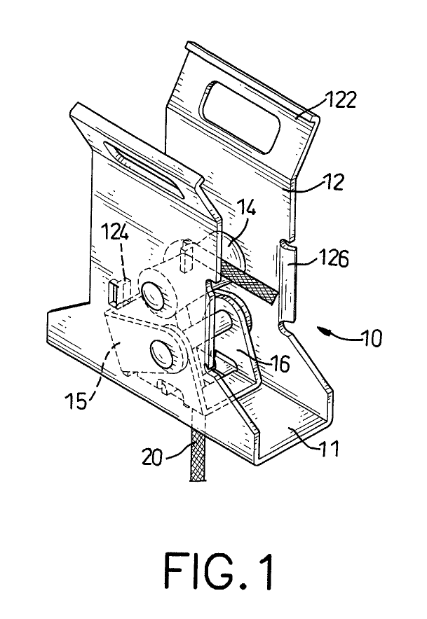

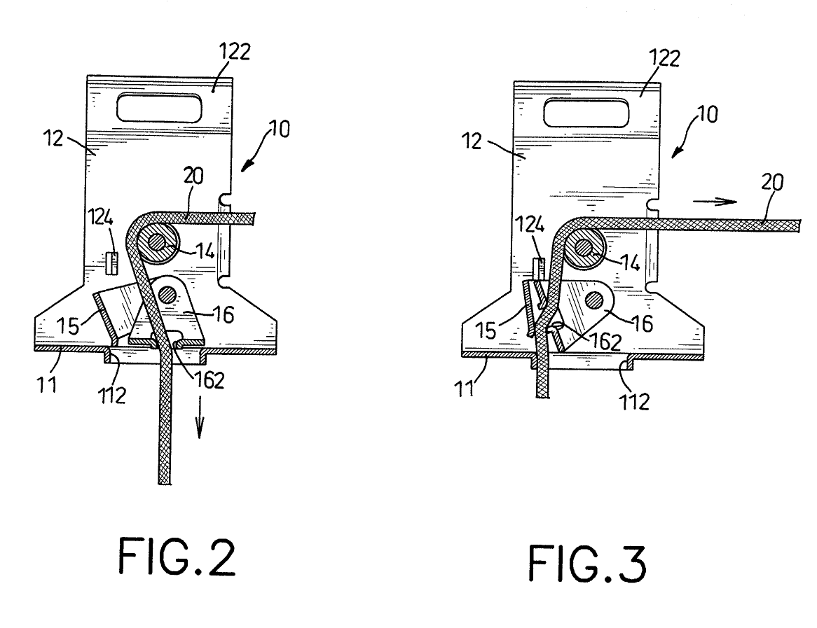

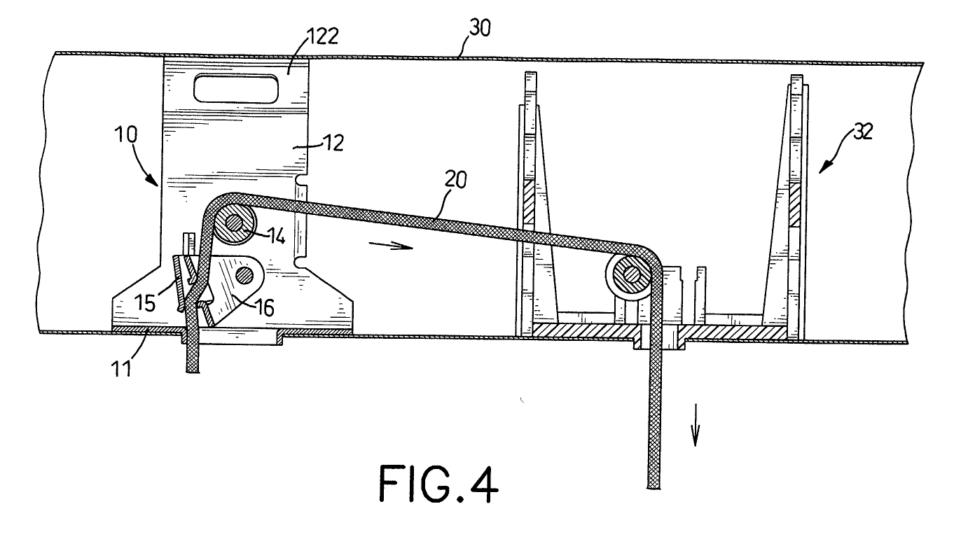

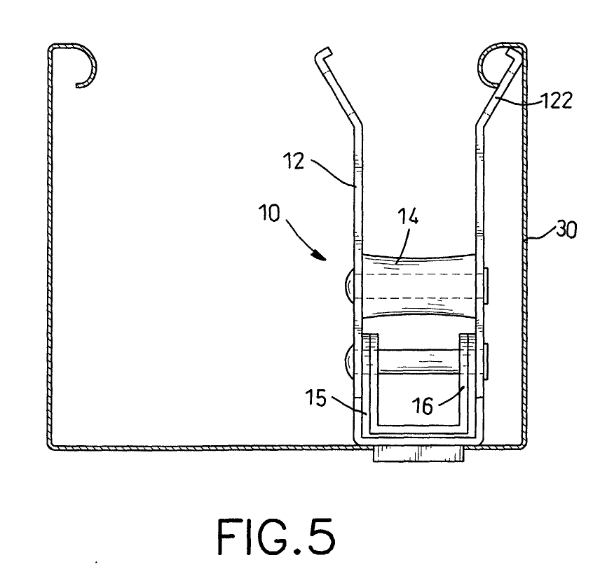

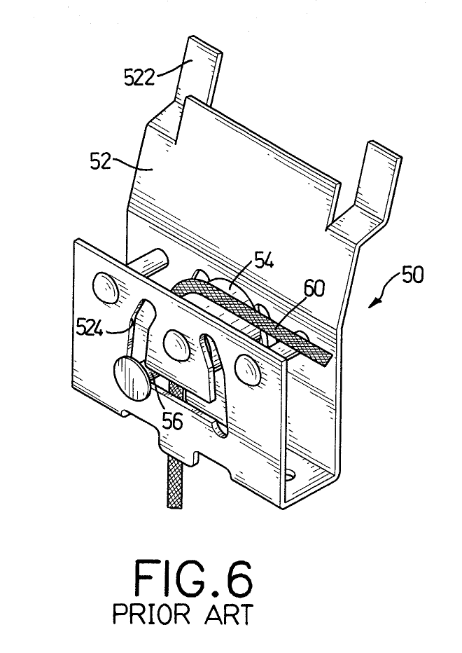

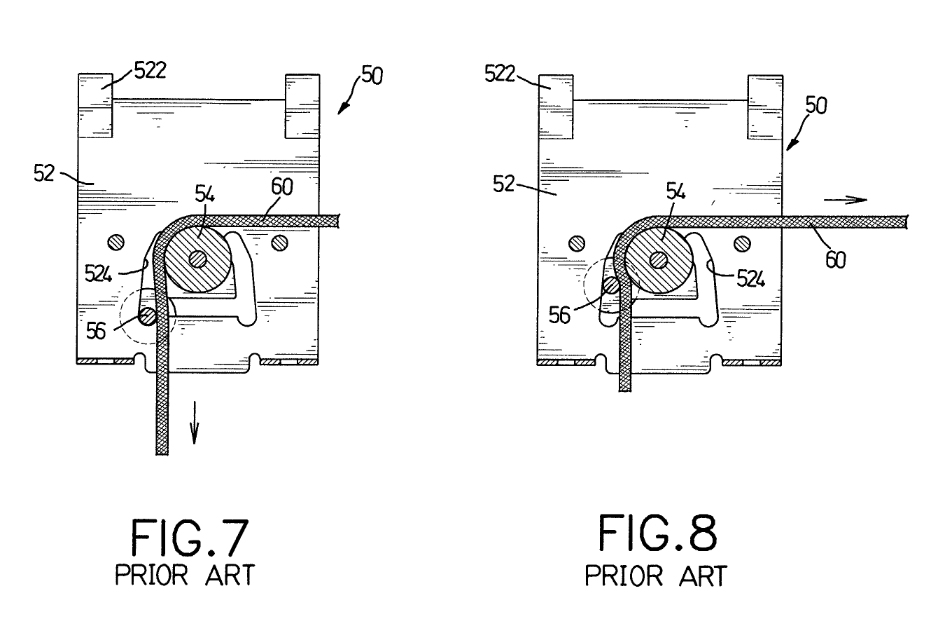

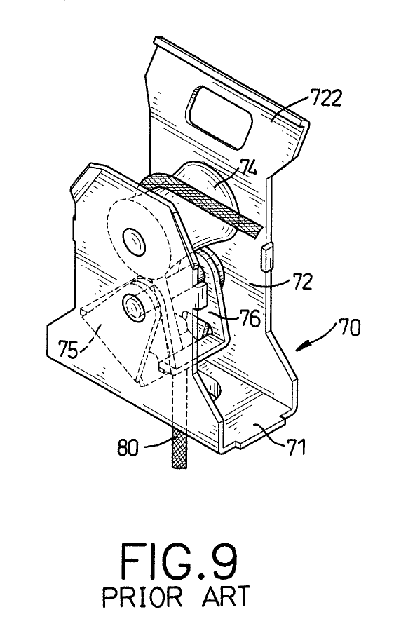

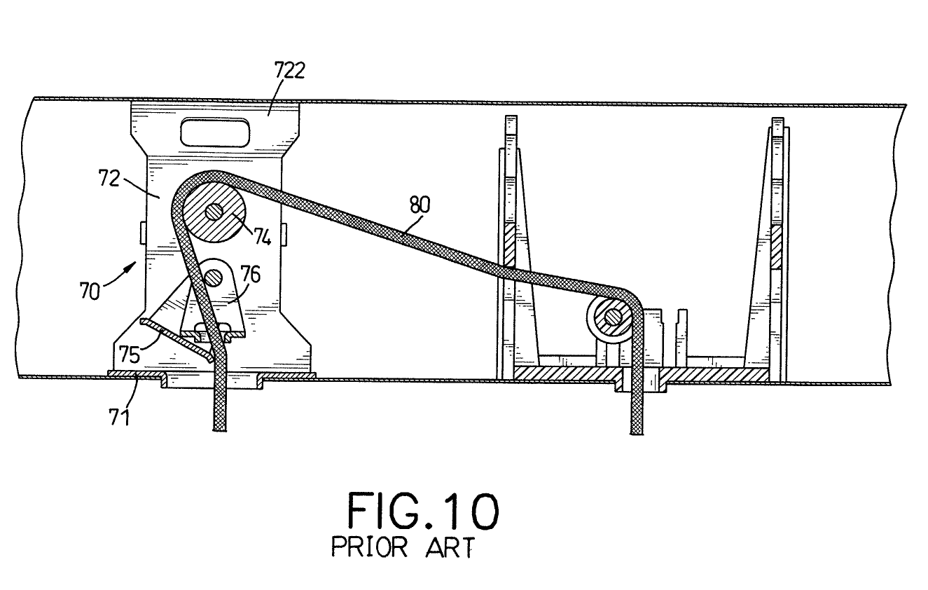

With reference to FIGS. 1 and 2, a lift cord locking device (10) for a Venetian blind in accordance with the present invention comprises a main frame, a roller (14), a locking frame (15) and a catch frame (16). The main frame comprises a base plate (11) and two side walls (12). The base plate (11) is adapted for a lift cord (20) of the Venetian blind extending through a through hole (112) defined in the base plate (11) in a longitudinal direction. The side walls (12) respectively extend upward from opposite sides of the base plate (11). Each of the side walls (12) has an engaging segment (122) extending outward from the top of the side wall (12). The roller (14) is rotatably mounted between the side walls (12) and is located below the middle position of the side walls (12). The lift cord (20) passes around the top of the roller (14) and extends to the tilt rod support (32) in a lateral direction as shown in FIG. 4. The locking frame (15) is pivotally mounted between the side walls (12) and is below the roller (14). The locking frame (15) has a bottom abutting the base plate (11), such that the rotating range of the locking frame (15) can be limited. The catch frame (16) is co-axially mounted with the locking frame (15) and is adapted for the lift cord (20) extending through a through hole (162) defined in the catch frame (16). The locking frame (15) and the catch frame (16) are substantially U-shaped, and the locking frame (15) is larger than the catch frame (16).

In addition, a stopping tab (124) is formed on each respective side wall (12) and is located above the locking frame (15) and below the roller (14). Each respective side wall (12) has an ear (126) extending outward from one side of the side wall (12) and corresponding to the roller (14).

With reference to FIGS. 2 and 3, when the lift cord (20) is pulled sideward, the locking frame (15) and the catch frame (16) will be actuated to rotate relative to the main frame by the lift cord (20). The locking frame (15) will stop rotating while the locking frame (15) abuts the stopping tabs (124). The catch frame (16) will keep rotating due to the force provided by the weight of the slats connected to the lift cord (20) until the catch frame (16) abuts the stopping tabs (124). The locking frame (15) will squeeze the lift cord (20) in cooperation with the catch frame (16), and the lift cord (20) is locked.

With reference to FIGS. 1 and 4, because the roller (14) is located below the middle position of the side walls (12), the lift cord (20) will laterally extend to the tilt rod support (32) at a smooth angle even when the lift cord locking device (10) is very close to the tilt rod support (32). This can keep the lift cord (20) from contacting the edge of passage in the tilt rod support (32) such that the lift cord (20) will be not broken during use. This can improve the safety of using the Venetian blind. In addition, the ears (126) on the side walls (122) can keep the lift cord (20) from contacting with the edge of the side walls (122) when the lift cord (20) extends out from the main frame. This can keep the lift cord (20) from being broken, whereby the safety of using the lift cord locking device (10) is further improved.

Furthermore, with the arrangement of the stopping tabs (124), the rotating travels of the locking frame (15) and the catch frame (16) can be reduced. This also can reduce the sideward distance of the lift cord (20) for locking the lift cord (20) such that to lock the lift cord (20) with the locking device (10) is convenient.

With reference to FIGS. 1 and 5, because both of the side walls (12) have an engaging segment (122), the lift cord locking device (10) can be positioned in different directions with different engaging segments (122) on the side walls (12). Therefore, the position of the locking device (10) can be changed when the direction of pulling the lift cord (20) faces a wall or another object, whereby the use of the lift cord locking device (10) is versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lift cord locking device for a Venetian blind comprising:
a base plate adapted for a lift cord of the Venetian blind extending through the base plate in a longitudinal direction;
two side walls respectively extending upward from opposite sides of the base plate;
a roller rotatably mounted between the side walls and adapted for the lift cord passing around a top of the roller so as to put the lift cord to extend in a lateral direction;
a locking frame pivotally mounted between the side walls and below the roller; and
a catch frame co-axially mounted with the locking frame and adapted for the lift cord extending through the catch frame,
wherein both of the side walls have an engaging segment extending outward from a top of the side wall; and
the roller is located below a middle position of the side walls so as to put the lift cord to extend in a lateral direction.

2. The lift cord locking device as claimed in claim 1, wherein a stopping tab is formed on each side wall and located above the locking frame and below the roller to stop the locking fame and the catch frame after the locking frame and the catch frame have been rotated in a desired travel.

3. The lift cord locking device as claimed in claim 1, wherein each respective side wall has an ear extending outward from one side of the side wall and corresponding to the roller.

4. The lift cord locking device as claimed in claim 1, wherein the locking frame and the catch frame are substantially U-shaped, and the locking frame is larger than the catch frame.

5. The lift cord locking device as claimed in claim 1, wherein the locking frame has a bottom abutting the base plate.
